(19) United States
(12) Patent Application Publication
(10) Pub. No.: US 2010/0073943 A1
(43) Pub. Date: Mar. 25, 2010

(54) Outdoor Light-Emitting Diode Light Fixture and Lamp Casing Device Thereof

(76) Inventors: Kuang-Chao Yeh, Taoyuan Hsien (TW); Cheng-Chieh Huang, Taoyuan Hsien (TW)

Correspondence Address: Troxell Law Office Pllc, 5205 Leesburg Pike, Suite 1404, Falls Church, VA, 22041, US

(21) Appl. No.: 12/234,645

(22) Filed: Sep. 20, 2008

(51) Int. Cl. F21V 29/00

(52) U.S. Cl. 362/373

(57) ABSTRACT

A lamp housing device for an outdoor light-emitting diode light fixture having high heat dissipation capability, which includes an upper casing, a cover body and a sunshade, wherein the cover body has light transmittance, and forms a holding chamber able to retain a light-emitting diode lamp set by pairing with the upper casing. The sunshade is located atop the outer surface of upper casing, and includes a plate and a plurality of fixing members. The fixing members are connected between the plate and the upper casing, thereby providing a spacing distance between the plate and the upper casing. Accordingly, the sunshade is able to reduce the ambient temperature of the light-emitting diodes during the daytime, and increase the rate of heat dissipation of light-emitting diodes when used at night.

### BACKGROUND OF THE INVENTION

(a) Field of the Invention

The present invention relates to an outdoor light-emitting diode light fixture and lamp casing device thereof, and more particularly to an outdoor light-emitting diode light fixture and lamp casing device thereof provided with high heat dissipation capability.

(b) Description of the Prior Art

Light-emitting diodes have gradually replaced traditional light sources because they are provided with advantages, including power saving, environmental protection, high brightness and long serviceable life. Moreover, light-emitting diodes have also been proposed for use in the area of exterior lighting equipment, such as street lamps. Referring to FIG. 1, which depicts a general street lamp using light-emitting diodes as light sources, and which primarily comprises an upper casing 91, a transparent cover member 92 and an array of light-emitting diodes 94 disposed within the upper casing 91 and a holding chamber 93 formed by the cover member 92.

Although light-emitting diodes are provided with the aforementioned advantages, however, light-emitting diodes produce a large amount of heat energy when emitting light; in particular, high power light-emitting diodes require greater need for increased heat dissipation effectiveness of the light fixture in order to prevent an excessive accumulation of heat energy causing a reduction in light emitting efficiency and serviceable life of the light-emitting diodes. Moreover, because street lamps are disposed outdoors, thus they are subjected to sunlight irradiation in the daytime, which also causes the lamp casing and the space within the lamp casing to retain heat energy, thereby affecting light emitting efficiency of the light-emitting diodes.

### SUMMARY OF THE INVENTION

Hence, an objective of the present invention is to provide a lamp casing device having high dissipation capability for an outdoor light-emitting diode light fixture, which is able to reduce retention of heat energy produced by sunlight irradiation, and is able to increase the flow of hot air.

Another objective of the present invention is to provide an outdoor light-emitting diode light fixture provided with high heat dissipation capability.

Accordingly, a lamp housing device for an outdoor light-emitting diode light fixture having high heat dissipation capability of the present invention comprises an upper casing, a cover body and a sunshade. The cover body has light transmittance, and forms a holding chamber able to retain a light-emitting diode lamp set by pairing with the upper casing. The sunshade is located atop the outer surface of upper casing, and comprises a plate and a plurality of fixing members. The fixing members are connected between the plate and the upper casing, thereby providing a spacing distance between the plate and the upper casing.

The sunshade is used to provide shielding from sunlight, thereby preventing sunlight from shining directly on the upper casing and reducing heat energy from being remained within the upper casing and the holding chamber. Moreover, pairing of the sunshade and the upper casing enables accelerating the flow of hot air, thereby substantially increasing the rate of heat dissipation.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a schematic view depicting an outdoor light-emitting diode light fixture of the prior art.

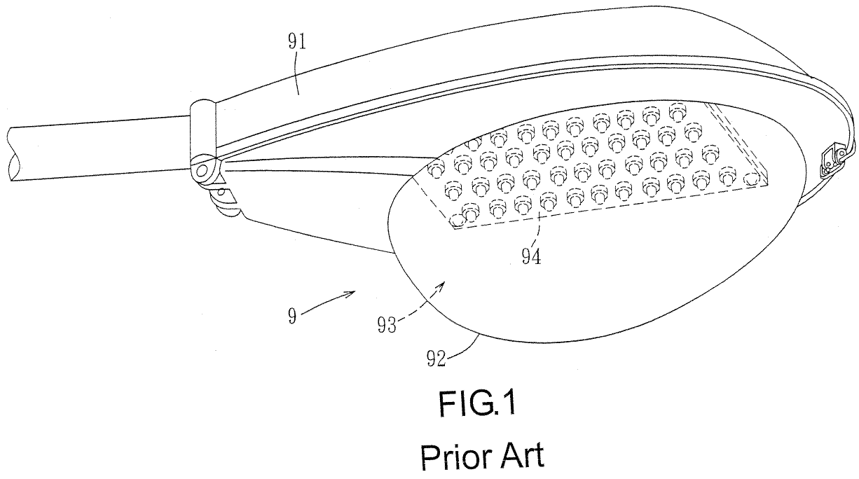

FIG. 2 is a side schematic view of a first preferred embodiment of the present invention depicting a lamp housing device for an outdoor light-emitting diode light fixture having high heat dissipation capability and the light-emitting diode light fixture provided with the lamp housing device.

FIG. 3 is a view from another angle depicting the first embodiment.

FIG. 4 is a side schematic view of a second preferred embodiment of the present invention depicting a lamp housing device for an outdoor light-emitting diode light fixture having high heat dissipation capability and the light-emitting diode light fixture provided with the lamp housing device.

FIG. 5 is a view from another angle depicting the second embodiment.

FIG. 6 is a side schematic view of a third preferred embodiment of the present invention depicting a lamp housing device for an outdoor light-emitting diode light fixture having high heat dissipation capability and the light-emitting diode light fixture provided with the lamp housing device.

FIG. 7 is a view from another angle depicting the third embodiment.

### DETAILED DESCRIPTION OF THE PREFERRED EMBODIMENTS

Before providing a detailed description of the present invention, it should be noticed that in the following description of the specification similar elements are represented by similar numbers.

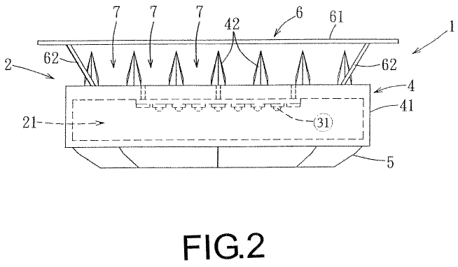

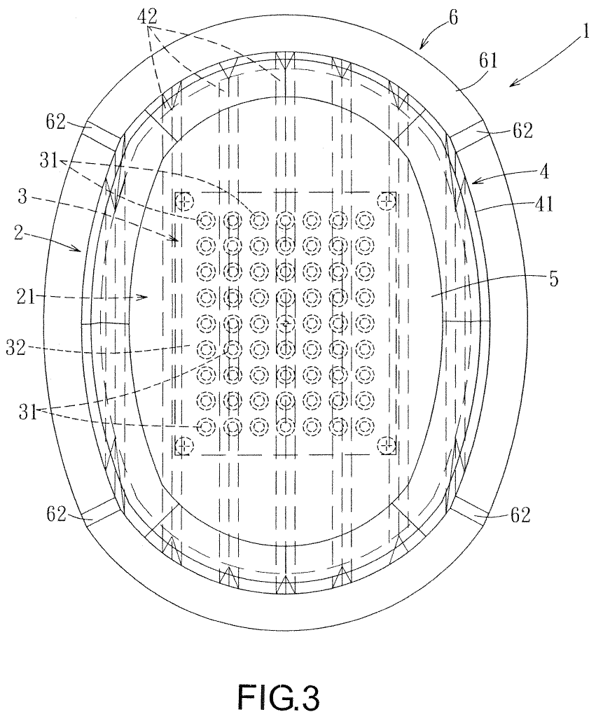

Referring to FIG. 2 and FIG. 3, which show a first preferred embodiment of the present invention depicting a lamp housing device for an outdoor light-emitting diode light fixture having high heat dissipation capability and the light-emitting diode light fixture provided with the lamp housing device, wherein the light-emitting diode light fixture 1 comprises a lamp housing device 2 and a light-emitting diode lamp set 3. The lamp housing device 2 comprises an upper casing 4 fabricated from metal material, a cover body 5 having light transmittance and a sunshade 6. The upper casing 4 comprises a casing portion 41 and a plurality of heat dissipating fins 42 formed on the outer surface of the casing portion 41. Mutual assembly of the cover body 5 within the lamp housing device 2 and the casing portion 41 within the upper casing 4 defines a holding chamber 21 able to retain the light-emitting diode lamp set 3. The light-emitting diode lamp set 3 is fixedly secured to the inner surface of the casing portion 41. The heat energy produced by the light-emitting diode lamp set 3 is transmitted outside the holding chamber 21 by means of the casing portion 41 and the heat dissipating fins 42, thereby increasing the rate of heat dissipation.

The sunshade 6 is located atop the casing portion 41 and comprises a plate 61 and a plurality of fixing members 62. Material having a heat insulation effect is preferred for the plate 61, and a single material can be used, or material having heat insulating layers (not shown in the drawings) can be used, the heat insulating layers being interlayers fabricated from material such as sponge, polystyrene, and the like, which enable increasing a sunshading and heat insulation effect. The fixing members 62 are connected between the plate 61 and the casing portion 41, thereby enabling fixing the plate 61 atop the casing portion 41, and thus providing a spacing distance between the plate 61 and the top end of the heat dissipating fins 42.

Area of the plate 61 is greater than that of the largest cross-sectional area of the upper casing 4, and the upper casing 4 is positioned within the orthogonal projection range of the plate 61. When fixed to the casing portion 41, the plate 61 completely screens sunlight from shining directly on the upper casing 4, which enables reducing the temperature of the holding chamber 21, thereby reducing the ambient temperature of the light-emitting diode lamp set 3 during the daytime, and decreasing the heat energy retained within the upper casing 4 and the holding chamber 21, which would otherwise affect the light emitting effectiveness of light-emitting diodes 31 of the light-emitting diode lamp set 3.

When the light-emitting diodes 31 are used as lighting at night, then the heat energy produced by the light-emitting diodes 31 is conducted away by means of the metal fabricated casing portion 41 and the heat dissipating fins 42. Air close to the heat dissipating fins 42 absorbs the heat energy conducted to the heat dissipating fins 42 and thereby becomes heated to form hot air, and because the plate 61 is positioned close to the area above the heat dissipating fins 42, thus, the region situated between the plate 61 and the heat dissipating fins 42 easily forms an even distribution of hot air, which enables an inflow of cold air to be rapidly sucked in. Furthermore, because the heat dissipating fins 42 assume a parallel arrangement, thus, the cold air is able to follow the direction of the arrangement of the heat dissipating fins 42 and enter the hot air region, where convection current with the hot air is produced, that is, the heat dissipating fins 42 function in conjunction with the plate 61 to form a plurality of air channels 7, wherein convection of cold and hot air forms, which enables accelerating flow of the hot air and substantially increasing the rate of heat dissipation.

The light-emitting diode lamp set 3 comprises the array of light-emitting diodes 31 and a circuit board 32, assembly of which to the lamp housing device 2 can be accomplished using existing light fixture technology for assembling light-emitting diodes; and high power light-emitting diodes are preferred for the light-emitting diodes. The light-emitting diode light fixture 1 of the present invention is applicable for assembly in street lamps (not shown in the drawings), and can be used to provide exterior lighting by an externally connected power supply. However, technology to assembly the light-emitting diode light fixture 1 to a street lamp is not the focal point of the present invention, which can be accomplished by referring to existing technology, and is thus not further described herein.

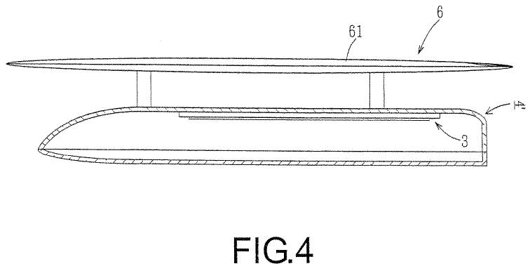

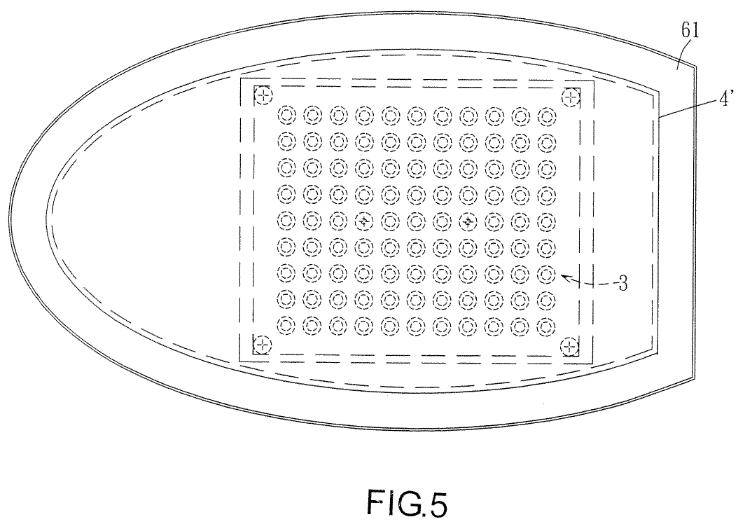

Referring to FIG. 4 and FIG. 5, which show a second preferred embodiment of the present invention depicting a lamp housing device for an outdoor light-emitting diode light fixture having high heat dissipation capability and the light-emitting diode light fixture provided with the lamp housing device, wherein the second preferred embodiment is approximately the same as the first preferred embodiment, however, an upper casing 4′ of the second preferred embodiment has no heat dissipating fins, but inner and outer surfaces of the upper casing 4′ are coated with high heat conducting coatings, thereby increasing the rate of heat dissipation of the upper casing 4′. Moreover, a spacing distance is provided between the plate 61 of the sunshade 6 and the upper casing 4′, thereby enabling the region situated between the plate 61 and the upper casing 4′ to easily form an even distribution of hot air and rapidly suck in an inflow of cold air, forming a transverse convection current of cold and hot air, which enables accelerating the flow of hot air and substantially increasing the rate of heat dissipation. At the same time, the inner and outer surfaces of the upper casing 4′ are coated with an additional coating having high surface transverse heat conducting effect, and use of such coatings enables achieving the aforementioned objectives and effectiveness.

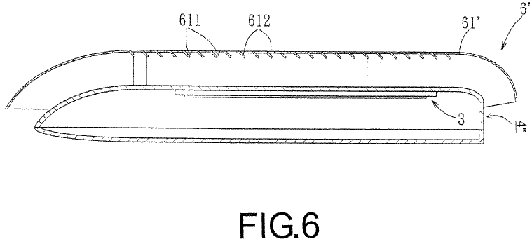

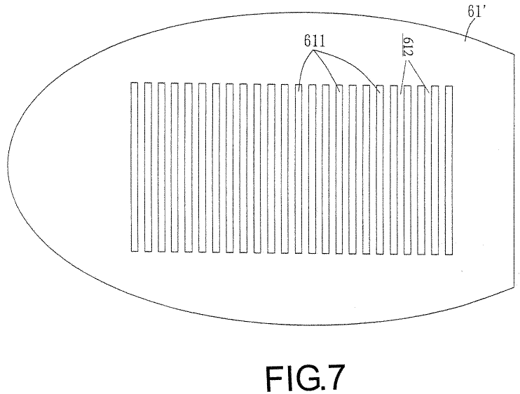

Referring to FIG. 6 and FIG. 7, which show a third preferred embodiment of the present invention depicting a lamp housing device for an outdoor light-emitting diode light fixture having high heat dissipation capability and the light-emitting diode light fixture provided with the lamp housing device, wherein primary components of the third preferred embodiment are approximately the same as those in the second preferred embodiment, however, the periphery of a plate 61′ of a sunshade 6′ assumes a curved arc shape, and the center region of the plate 61′ is formed with a plurality of gate holes 611. An oblique baffle plate 612 is located between each of the gate holes 611 to prevent sunlight from shining directly on an upper casing 4″. However, hot air between the plate 61′ and the upper casing 4″ can be dispersed through the gate holes 611, that is, the region between the plate 61′ and the upper casing 4″ forms an even distribution of hot air, which enables an inflow of cold air to be rapidly sucked in, thereby forcing the hot air upwards and dispersing thereof to the atmosphere through the gate holes 611, thus accelerating the dispersal of the hot air.

In conclusion, the lamp casing device of the present invention is able to use a sunshade to shield sunlight from shining directly on an upper casing, thereby reducing the daytime ambient temperature of a light-emitting diode lamp set, and preventing heat energy from being retained within the upper casing and holding chamber, which would otherwise affect the light emitting effectiveness of the light-emitting diodes. Moreover, pairing of the sunshade and upper casing enables accelerating the flow of hot air, which substantially increases the rate of heat dissipation.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A lamp housing device for an outdoor light-emitting diode light fixture having high heat dissipation capability, comprising:
an upper casing;
a cover body having light transmittance, and pairing of the cover body and the upper casing forms a holding chamber able to retain a light-emitting diode lamp set; and
a sunshade located atop the outer surface of the upper casing, comprising a plate and a plurality of fixing members, the fixing members are connected between the plate and the upper casing, thereby providing a spacing distance between the plate and the upper casing.

2. The lamp housing device for an outdoor light-emitting diode light fixture having high heat dissipation capability according to claim 1, wherein area of the plate of the sunshade is greater than that of the largest cross-sectional area of the upper casing, and the upper casing is positioned within the orthogonal projection range of the plate.

3. The lamp housing device for an outdoor light-emitting diode light fixture having high heat dissipation capability according to claim 1, wherein the upper casing is fabricated from metal material, and surfaces are coated with a heat conducting coating.

4. The lamp housing device for an outdoor light-emitting diode light fixture having high heat dissipation capability according to claim 1, wherein the upper casing comprises a casing portion and a plurality of heat dissipating fins formed on the outer surface of the casing portion.

5. The lamp housing device for an outdoor light-emitting diode light fixture having high heat dissipation capability according to claim 1, wherein the sunshade is provided with a heat insulating layer.

6. The lamp housing device for an outdoor light-emitting diode light fixture having high heat dissipation capability according to claim 1, wherein a plurality of gate holes are formed on the sunshade.

7. An outdoor light-emitting diode light fixture having high heat dissipation capability, comprising:
an upper casing;
a cover body having light transmittance, and pairing of the cover body and the upper casing forms a holding chamber;
a light-emitting diode lamp set fixedly secured to the upper casing and positioned within the holding chamber; and
a sunshade located atop the outer surface of the upper casing, and comprising a plate and a plurality of fixing members, the fixing members are connected between the plate and the upper casing, thereby providing a spacing distance between the plate and the upper casing.

8. The outdoor light-emitting diode light fixture having high heat dissipation capability according to claim 7, wherein area of the plate of the sunshade is greater than that of the largest cross-sectional area of the upper casing, and the upper casing is positioned within the orthogonal projection range of the plate.

9. The outdoor light-emitting diode light fixture having high heat dissipation capability according to claim 7, wherein the upper casing is fabricated from metal material, and surfaces are coated with a coating having high surface transverse heat conducting effect.

10. The outdoor light-emitting diode light fixture having high heat dissipation capability according to claim 7, wherein the upper casing comprises a casing portion and a plurality of heat dissipating fins formed on the outer surface of the casing portion.

11. The outdoor light-emitting diode light fixture having high heat dissipation capability according to claim 7, wherein the sunshade is provided with a heat insulating layer.

12. The outdoor light-emitting diode light fixture having high heat dissipation capability according to claim 7 wherein a plurality of gate holes are formed on the sunshade.
